(19) United States
(12) Patent Application Publication
(10) Pub. No.: US 2020/0097879 A1
(43) Pub. Date: Mar. 26, 2020

(54) TECHNIQUES FOR AUTOMATIC OPPORTUNITY EVALUATION AND ACTION RECOMMENDATION ENGINE

(71) Applicant: Oracle International Corporation, Redwood Shores, CA (US)

(72) Inventors: Ananth Venkata, San Ramon, CA (US); Rajesh Balu, Bangalore (IN); Vikas Agrawal, Hyderabad (IN); Naren Chawla, Pleasanton, CA (US); Archana Dixit, Agra (IN)

(73) Assignee: Oracle International Corporation, Redwood Shores, CA (US)

(21) Appl. No.: 16/580,746

(22) Filed: Sep. 24, 2019

Related U.S. Application Data
(60) Provisional application No. 62/736,034, filed on Sep. 25, 2018.
(60) Provisional application No. 62/747,220, filed on Oct. 18, 2018.

(51) Int. Cl. G06Q 10/06; G06N 5/04; G06K 9/62

(52) U.S. Cl. CPC G06Q 10/06375; G06N 5/04; G06K 9/6215; G06K 9/6231; G06Q 10/063114

(57) ABSTRACT

Described herein are systems and techniques for identifying at-risk opportunities and generating a recommendation that can be used by the representatives to help salvage the opportunities. Historical information as well as machine learning algorithms are used to identify the failing opportunities by classifying new and currently in-pursuit opportunities using information from past opportunities to identify which of the new and in-pursuit opportunities might be at risk. Distances between opportunities are estimated based on local neighborhoods determined by relevant variables influencing those opportunities in the local neighborhood. The shortest distance between at risk opportunities and winning opportunities can be identified and utilized to generate the recommendation based on the relevant variables for the shortest path. In some embodiments, an ordered list of actions or changes to actions needed for a successful disposition of the opportunity may be generated and provided to the representative.

### CROSS-REFERENCES TO RELATED APPLICATIONS

This application is a non-provisional of and claims the benefit of and priority to U.S. Provisional Patent Application No. 62/736,034, filed Sep. 25, 2018, entitled “TECHNIQUES FOR AUTOMATIC OPPORTUNITY EVALUATION AND ACTION RECOMMENDATION ENGINE,” and U.S. Provisional Patent Application No. 62/747,220, filed Oct. 18, 2018, entitled “TECHNIQUES FOR AUTOMATIC OPPORTUNITY EVALUATION AND ACTION RECOMMENDATION ENGINE,” the content of each of which is herein incorporated by reference in its entirety for all purposes.

### BACKGROUND OF THE INVENTION

Companies have many sales opportunities at any given point in time. Deals are being handled by various sales representatives, some of which are going well and others that are not. Identifying which deals are going well and which are not can be challenging. Identifying why the deal is going wrong and figuring out a way to help the sales rep salvage the deal is an even bigger challenge. Current solutions are primarily manual with companies relying on managers to know which sales representatives are handling deals and know enough about the deal to provide guidance to the sales representative.

### BRIEF SUMMARY OF THE INVENTION

Using historical information as well as machine learning algorithms, failing opportunities may be improved using recommendations generated automatically. Specifically, the new and currently in-pursuit opportunities may be classified using information from past opportunities to identify which of the new and in-pursuit opportunities might be at risk and, by estimating distances between opportunities based on local neighborhoods determined by relevant variables influencing those opportunities in the local neighborhood, the shortest distance between at risk opportunities and winning opportunities can be identified and utilized to generate the recommendation based on the relevant variables for the shortest path or an ordered list of actions or changes to actions needed for a successful disposition of the opportunity.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for automatic opportunity evaluation and salvage. The method may include classifying many open and closed (i.e., new and completed) opportunities within a multi-dimensional space, where each dimension of the multi-dimensional space is associated with a variable relevant to at least one of the opportunities being classified. The classification may include grouping, using statistical moment based distance measures, subsets of the opportunities into local neighborhoods where specific variables directly or indirectly influence the opportunities within each neighborhood. The method may also include assigning a positive or a negative score indicating that it is a won opportunity (for closed opportunities) or on pace to succeed (for open opportunities) opportunity with a positive score or indicating that it is a lost opportunity (for closed opportunities) or at risk (for open opportunities) with a negative score to each of the opportunities based on a locally faithful model created in the multi-dimensional space. The method may also include identifying a subset of the variables in each of the local neighborhoods, and for a first opportunity having an indicator of the negative outcome in a first local neighborhood, identifying, based on at least one of the subset of the variables, a second opportunity within the first local neighborhood having the indicator of the positive outcome. The method may also include calculating a distance, based on associated variables of the subset of the variables for the first local neighborhood, between the first opportunity and the second opportunity having the indicator of the positive outcome. The method may also include executing a simulation to find a shortest path, based on the calculated distance, which changes the score for the first opportunity from the negative value to the positive value by changing one or more of the variables. The method may also include generating a recommendation for salvaging the first opportunity based on the shortest path. Other embodiments of this aspect include corresponding computer systems, apparatus, and computer programs recorded on one or more computer storage devices, each configured to perform the actions of the methods.

Implementations may include one or more of the following features. In some embodiments, identifying the subset of variables includes selecting the subset of variables for each local neighborhood having the greatest gradient change within the local neighborhood. In some embodiments executing the simulation includes identifying a list of the variables that, when changed for the first opportunity, changes the score for the first opportunity from the negative value to the positive value, and where generating the recommendation for the first opportunity is further based on the list of variables with the maximal gradient change. In some embodiments, the method may also include generating a natural language message based on the recommendation to provide to a sales representative in a graphical user interface. In some embodiments, grouping subsets of the opportunities into local neighborhoods is based at least in part on at least one of a size of each opportunity, timing of each opportunity, one or more products involved in each opportunity, similarities of activities in each opportunity, or one among dozens of influencing variables. In some embodiments, the method may also include capturing first episodic memory of at least one action performed by a first sales representative for the first opportunity, capturing second episodic memory of at least one action performed by a second sales representative for the second opportunity, and determining that the at least one action performed by the second sales representative is related to at least one of the associated variables used to calculate the distance between the first opportunity and the second opportunity. In such embodiments, generating the recommendation is further based on the at least one action performed by the second sales representative that differs from the at least one action performed by the first sales representative in a temporal, ordinal, or categorical sense. In some embodiments, assigning the score to the first opportunity includes at least one of comparing an activity level or category between the first opportunity with the second opportunity, identifying a frequency of change of a projected close date of the first opportunity, identifying a frequency of deal value change of the first opportunity, or identifying a progression rate for the first opportunity or one of several such indicators directly impacting the success of the opportunity. In some embodiments, the method may include calculating the hypersurface of the switch-over boundary between opportunities having the positive value and opportunities having the negative value within the first local neighborhood. In such embodiments, the method may also include calculating a second distance, based on the associated variables of the subset of variables for the first local neighborhood, between the first opportunity and the boundary. In such embodiments, executing the simulation may further include finding a second shortest path, based on the second distance, between the first opportunity and the boundary. In such embodiments, generating the recommendation for the first opportunity is further based on the second shortest path between the first opportunity and the boundary. Implementations of the described techniques may include hardware, a method or process, or computer software on a computer-accessible medium.

### BRIEF DESCRIPTION OF THE DRAWINGS

FIG. 1 illustrates an exemplary opportunity scoring and recommendation system, according to some embodiments.

FIG. 2 illustrates an exemplary illustration of an opportunity neighborhood, according to some embodiments.

FIG. 3 illustrates an exemplary method for opportunity scoring and recommendations, according to some embodiments.

FIG. 4 illustrates a user interface for opportunity scoring and recommendations, according to some embodiments.

FIG. 5 illustrates another user interface for opportunity scoring and recommendations, according to some embodiments.

FIG. 6 illustrates yet another user interface for opportunity scoring and recommendations, according to some embodiments.

FIG. 7 illustrates an exemplary networked system, according to some embodiments.

FIG. 8 illustrates an exemplary cloud based system, according to some embodiments.

FIG. 9 illustrates an exemplary computer system, according to some embodiments.

### DETAILED DESCRIPTION OF THE INVENTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

An embodiment is directed to identifying and scoring opportunities, including business deals, sales opportunities, and other projects; determining whether the opportunity is likely to close or not; and providing a next best action for the opportunities that are not likely to close or that are at risk. Determining whether the opportunity is likely to close or whether it may be at risk may be based on actions of sales persons, health of the existing relationship with the customer such as service quality and history, and external factors including, but not limited to, news and social media. Providing a series of next best actions (NBA)/recommendations for the opportunities that are not likely to close or that are at risk may include sales personnel actions and customer service quality improvements.

Opportunities within a sales group can go through multiple stages at varying velocities, can have associated activities (e.g., email, calls, meetings, tasks, revenue forecast changes, and so forth), and are influenced by several internal and external events at micro (e.g., the opportunity) and/or macro (e.g., the account) levels. Structured and unstructured data associated with past opportunities can provide a data source for building a model to leverage the information to assign a probability score to an opportunity instance. The probability score can indicate the probability that the opportunity will close successfully with a sale. Furthermore, a rationale can be provided to a user as to the specific reasons the probability score was assigned. Additionally, based on historical data and model simulations, prescriptive guidelines can be provided to the sales representative in terms of potential next-best actions that can be taken. For instance, the sales representative can be notified of what activities can be performed to move an at-risk opportunity to a better state or what activities can be performed to close an opportunity with low risk.

The historical information may be obtained using automated data entry into a database from other data sources or by mining the information from other data sources. For example, email communications, phone call records, phone call recordings, and notes of conversations between a sales representative and a customer in which an opportunity successfully closed can provide insight into what steps are successful. The system can algorithmically score each opportunity in terms of quantifying a probability of losing (not closing the deal/opportunity) or winning (successfully completing the sale/opportunity). The system can also provide a next best action recommendation for the opportunity based on the historical data and the probability score.

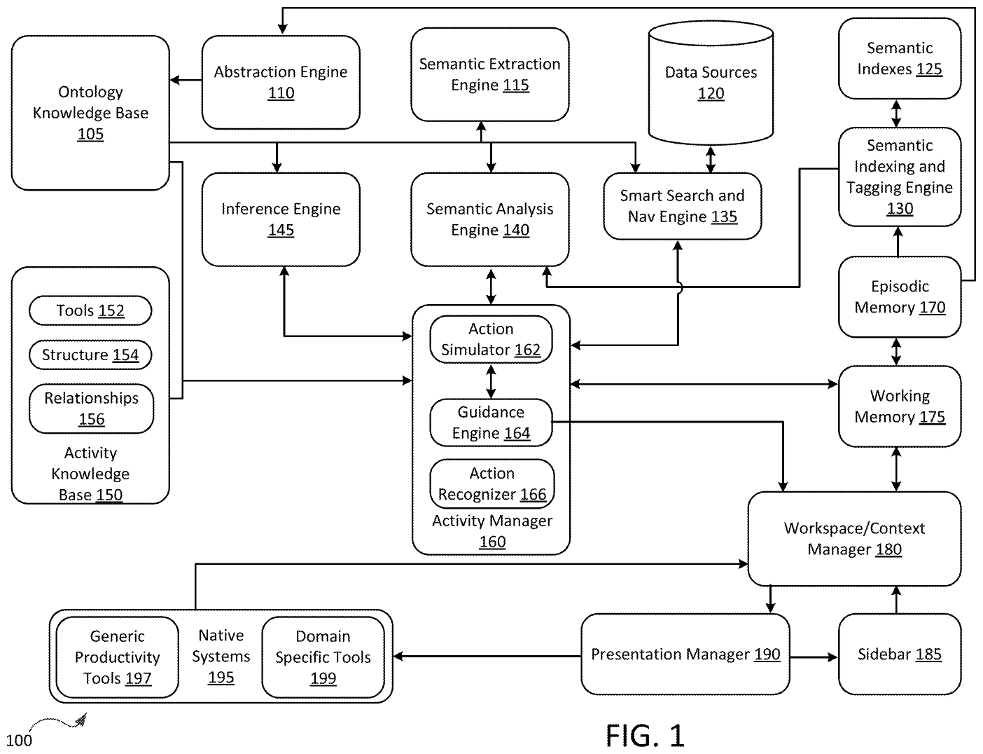

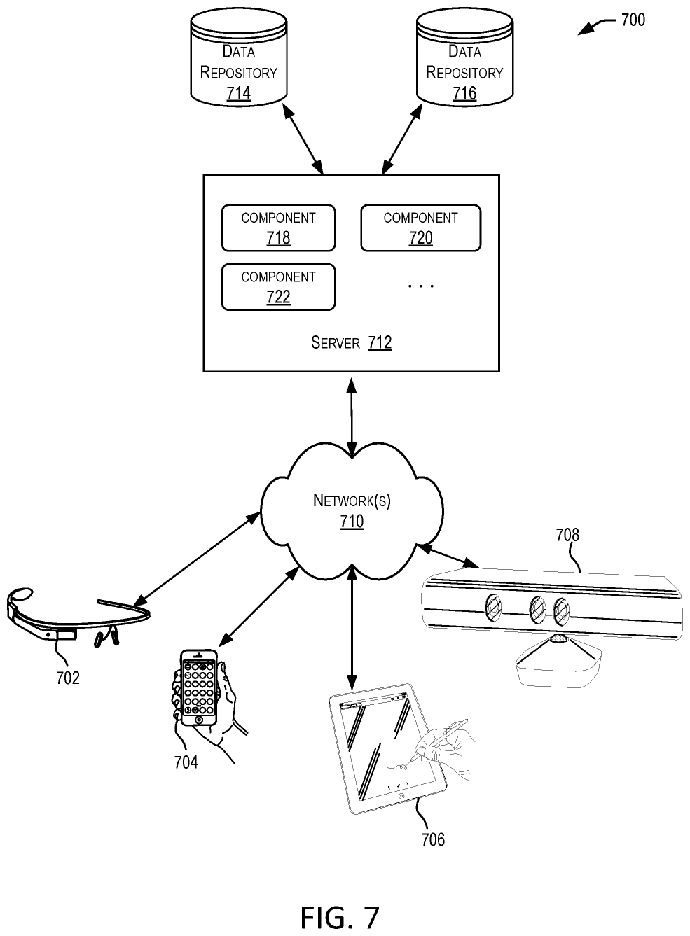

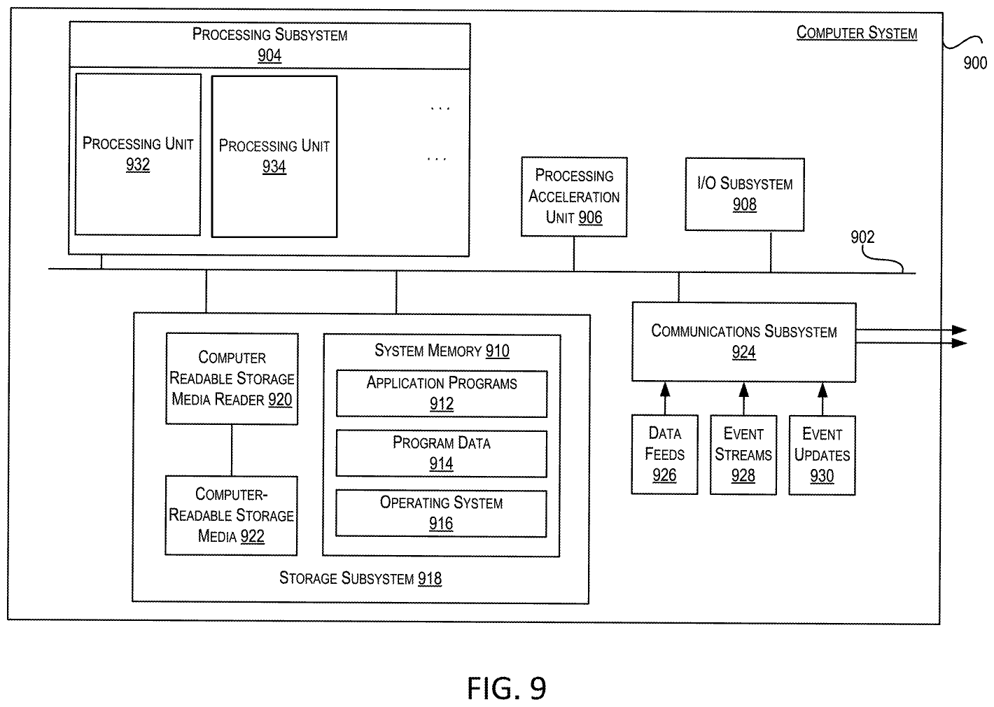

Turning to FIG. 1, a simplified block diagram of a system 100 for opportunity scoring and recommendation is illustrated. The system 100 includes an ontology knowledge base 105, an abstraction engine 110, a semantic extraction engine 115, data sources 120, semantic indexes 125, semantic indexing and tagging engine 130, smart search and navigation engine 135, semantic analysis engine 140, inference engine 145, activity knowledge base 150, activity manager 160, episodic memory 170, working memory 175, workspace/context manager 180, sidebar 185, presentation manager 190, and native systems 195. While specific components are included in system 100, the functionality described may be incorporated into fewer or more components without impacting the scope of this disclosure. Further, system 100 may perform other functionality not described herein for the purposes of simplicity. For example, while a transceiver is not displayed in system 100, system 100 includes components for communication with other computing systems to receive and transmit information. System 100 may be one or more computer systems, such as computer system 900 of FIG. 9. System 100 may be incorporated into a networked system 700 as, for example, one or more servers 712 as described with respect to FIG. 7. System 100 may optionally be incorporated into a cloud-based system 800 as, for example, cloud infrastructure system 802.

Ontology knowledge base 105 can be any suitable space in memory including, for example, a database. Ontology knowledge base 105 can include information regarding concepts or categories related generally to opportunities and relationships between them. For example, the listing of variables in Table 1 may be included in ontology knowledge base 105 and may include relationships between the various variables including how each variable belongs to higher (broader) or lower (narrower) categories in the ontology hierarchy. Ontology knowledge base 105 may be partly explicitly coded by experts of the domain and partly encoded as task sequence embeddings using neural networks including, but not limited to, neural networks like bidirectional long short term memory (“LS™”) with variable attention and temporal attention to encode what actions follow which others and which are expected to come up in sequence for successful versus unsuccessful opportunities. Ontology knowledge base 105 can receive additional information from abstraction engine 110 that is gained from processing episodic memory for sales opportunities including, for example, but not limited to, bidirectional LSTMs. The additional information from abstraction engine 110 can be incorporated into the ontology knowledge base 105 to grow and develop the ontology knowledge base 105 over time. Abstraction engine 110 receives information from episodic memory 170, which is abstracted for entry into the ontology knowledge base 105.

Activity knowledge base 150 can be any suitable space in memory including, for example, a database. Activity knowledge base 150 can include tools 152, structure 154, and relationships 156. Tools 152 can include system resources and tools available for use in identifying and classifying activities of the sales representative with respect to an opportunity. Structure 154 can include activity structure information that can be used to classify activities of the sales representative with respect to an opportunity, including which activities are related to others in the form of a deterministic finite automata model with transition probabilities defining the edges, and the nodes being canonical atomic activities, some of which may be hard-coded by domain experts and others discovered as embedded activities within the action stream, and later confirmed by domain experts as these activities are found to be predictive of higher success rates in opportunities. Relationships 156 can include important entities and relationships that can be used to classify activities of the sales representative with respect to an opportunity. Together, the tools 152, structure 154, and relationships 156 are used within activity knowledge base 150 by activity manager 160 to accurately classify, rank, and calculate the probability of winning the opportunity through activities and actions of sales representatives on open opportunities (e.g., non-completed deals).

Native systems 195 may include generic productivity tools 197 and domain specific tools 199. The generic productivity tools 197 may include, for example, email systems for sales representatives, smartphone calling applications, instant messaging applications, sales tracking tools, metrics tools, and so forth. Domain specific tools 199 may include, for example, specific product sales tracking tools and the like. Native systems 195 may obtain data from the generic productivity tools 197 and domain specific tools 199 for each sales representative, while retaining the structure of activities, and provide the data and information to the workspace/context manager 180. Capturing activities of the sales person for the modeled opportunities and providing context-specific guidance may be performed by native systems 195. In some embodiments, improvements to the system may include capturing episodic memory using a user device application resident on the user's device. Episodic memory of each action of the sales person may include emails, phone calls, memos, presentations, travel, success and movement of opportunity, service quality of past opportunities at customer, competitive information, and the like. The system may capture, store, and replay the context of the activity being performed, as well as the context information of previous tasks and activities. The captured activity information may be stored in a structured form including all the information relative to the process and its context, and making it available to other modules to access and modify this information. All procedural information about the discourse being performed, its current state, the different dialog interactions and its responses may also be stored.

The workspace/context manager 180 can receive information regarding scoring and guidance of sales opportunities and provide the guidance information to the presentation manager 190. The workspace/context manager 180 can obtain information about activities of the sales representative for opportunities from the native systems 195, the sidebar 185, the working memory 175, and the guidance engine 164. The workspace/context manager 180 provides information received from sidebar 185 and native systems 195 to working memory 175 for processing and incorporation into the activity manager and analysis engines. Workspace/context manager 180 receives guidance from guidance engine 164 as described in more detail below. The guidance is provided to the presentation manager 190 for display to the user.

The presentation manager 190 is used to present information to the user through the user interface of the user's system, showing, for example, the statistically most relevant information, and nothing else, based on the opportunity score determined from the bidirectional LSTM model working with the deterministic finite automata models-based predictions. The presentation manager receives information from the workspace/context manager 180 for incorporation into the sidebar 185 of the user's interface. For example, recommendations (i.e., guidance) are made to the user for his or her sales opportunities via sidebar 185. The opportunity scores may also be provided in the user's interface.

Working memory 175 receives information from activity manager 160 about the existing known structure of activity streams, episodic memory 170 about the present ongoing activity pathways which may sometimes diverge, in part, from canonical activity pathways, and workspace/context manager 180 about the specific context of the user in terms of opportunities they are working on, including the user's past, present, and planned activities, their collaborative relationships, and their role and responsibilities with respect to a given opportunity. Working memory 175 can be a sequential acyclic graph of canonical atomic activities and can store all working memory information for open opportunities for which activities are being performed. For the purpose of the model, when an activity is repeated, it is seen as an explicit next step of the sequence, and not as a return to a previous state in the acyclic graph. In some embodiments, the elements of the working memory 175 can be organized by sales representative/user explicitly, and in other embodiments the working memory 175 is classified and organized based on the categories and sequences defined in activity knowledge base 150. The working memory 175 can store the activities of the sales representative as received from the workspace/context manager 180 from the user systems and from the activity manager 160, and on the activity completion, the probabilistic graphical models are stored in episodic memory 170. The working memory 175 may store specific activities that are needed for processing the information related to a specific opportunity. Working memory 175 may be volatile memory, such that the working memory 175 contains details for a specific opportunity while processing information for that opportunity, but the information is stored in permanent memory (such as data sources 120) for storage outside the session, including through generalization via episodic memory 170.

Episodic memory 170 receives information from both the activity working memory and context working memory 175, including specific user (e.g., sales representative) information of context, activity, role, responsibilities, and connections. Episodes may be specific actions that can be connected together as a graph to create an episode which encapsulates the performance of a larger activity. For example, an email exchange for a specific purpose, along with a phone call, and entering information into an online database may form an episode with a temporal probabilistic graphical representation. Episodic memory 170 may be any suitable volatile memory for identifying episodes of activity of a user for an opportunity, saved for each session of use activity and paused while user inactivity is detected. The episodes can be obtained from working memory 175, and episodic memory can group the activities of the working memory 175 into specific episodes in the form of probabilistic graphical models.

Semantic indexing and tagging engine 130 receives input from episodic memory 170 and performs semantic indexing and tagging for each episode in terms of the ontology and activity knowledge bases 105 and 150 to assign specific meaning to specific activities. This may be accomplished in multiple ways including by matching to existing templates or by task sequence embeddings similar to sequence embeddings and word embeddings in natural language models. The episodes of activity, for example an email thread, may have natural language information that can be parsed out and certain semantic indexes can be applied or identified and tagged by the semantic indexing and tagging engine 130, including named entities of interest, sentiments with respect to named entities, and similarity of meaning to previous utterances based on embedding vector distances. The semantic indexing and tagging engine 130 may receive or look up semantic information from semantic indexes 125 to identify the appropriate indexing and tagging to apply to the information in the episode based on past generalizations, which include, but are not limited to, the aforementioned task sequence embeddings, categories of activities, and information obtained from communications. For example, an email exchange may be related to setting up a meeting, and the semantic indexing and tagging may identify the purpose of the email episode (e.g., to schedule a meeting), the temperament of the potential client (e.g., excited to schedule it quickly, resistant to scheduling, indifferent implied by scheduling it weeks away, rescheduling it on multiple occasions, or the like), the current state of the sales representative (e.g., wasted time by rescheduling, challenges expected in meeting the customer's needs, or the like), and so forth. Semantic indexes 125 may be generated by learning generalized rules into a semantic memory (semantic indexes 125) that include generalizations based on episodes from multiple sales people, customers, and opportunities over time. Improvements may also include providing guidance based on the context of the activities and the context narrows the search space within past episodic memory providing a multi-fold computational speedup in the search process. The system may detect user intent based on a search of past episodes of the user and the user's colleagues, using domain ontology and a reference activity knowledge base. The system may use this information to identify the next best steps from the simulation engine and provide to the results to the user. The system may further determine whether any of the steps can be taken based on known constraints and resources, and generalizations-based rules.

Semantic analysis engine 140 can receive the semantic indexed and tagged information for an episode and provide analysis including using information from the ontology knowledge base 105 and semantic extraction engine 115. The semantic extraction engine 115 can extract the relevant semantic information that has been tagged and indexed based on the type of opportunity being evaluated and its position in the sales flow. For example, an opportunity in the final stage having an email exchange pushing the closing date a month later may identify the email exchange as a bigger problem than an opportunity in an earlier stage having the same type of closing date push. The semantic analysis engine 140 can determine whether the semantic information is relevant and provide a score associated with the activity and provide the information to the activity manager 160.

The inference engine 145 may and smart search and navigation engines 135 each provide information to the activity manager 160 that are used to generate opportunity scores and provide guidance to users. The inference engine specifically allows deductive and abductive reasoning for finding what states are inconsistent and what is the explanation for the current state, respectively. The inference engine further uses explicit what-if simulations to determine how to change the current state of the opportunity to a more favorable state. The explicit what-if simulations include, but are not limited to, multivariate Monte Carlo simulations within pre-specified boundaries on the limits on the potential values of the variables which represent potential interventions.

The activity manager 160 includes the action simulator 162, guidance engine 164, and action recognizer 166. The activity manager receives information on the current activities and context from the working memory 175, the smart search and navigation engine 135 to find next actions on the path, the semantic analysis engine 140, the inference engine 145, the ontology knowledge base 105, and the activity knowledge base 150. With these sources of information, including opportunity specific information about the activities associated with an opportunity, an opportunity can be evaluated based on its activities and known previous activities to determine a score and guidance for the sales representative. The opportunity may be scored in two ways: as a probability of winning or as a size of the business. In some cases, the opportunity may be scored as an expected value of business based on a combination of the expected probability of winning and the size of business expected. The probability of winning is modeled as a classification problem, and the size of the business is modeled as a regression problem. The classification model is generated using convolutional neural networks chained with recurrent neural networks, and the regression model is generated with boosting based decision tree ensembles. The action recognizer 166 can identify specific actions from the working memory and semantic analysis engine 140 to determine relevant actions based on characteristics of past successful and unsuccessful opportunities and their temporal dynamics of actions. Data regarding successful and unsuccessful opportunities, including reference models of activities, may be obtained from the opportunities and sales database found in the customer relationship management (“CRM”) system and activity knowledge base 150 respectively.

Action simulator 162 can perform simulations (e.g., Monte Carlo simulations) to determine scores of the opportunities and potential shortest paths needed to be traversed to get a winning classification. These shortest paths are used by the guidance engine 164 to generate recommendations for the opportunity to help the sales representative make corrections to attempt to salvage the opportunity if the opportunity is at a risk of loss.

Email communications and other structured and unstructured historical data are captured from data sources 120. Data sources 120 can include historical information about opportunities including closing information and other activities that occurred during the various stages of an opportunity including, for example, email messages, calls, meetings, tasks, revenue forecast changes based on order changes (e.g., price changes and/or quantity changes), timeline changes (e.g., closing date changes), and so forth. The data sources 120 can be mined by machine learning algorithms to identify types of opportunities, opportunities that were successful, the products involved in opportunities, the activities that occurred during the opportunities, and so forth. The information gleaned from the mining can be used to assess current opportunities using machine learning based models including but not limited to capsule-network based neural networks for short range order and long short term memory for long range order to find if there is novel information of interest to the end user. Specifically, smart search and navigation engine 135 can search for information relevant to improving the prospects of each opportunity, and provide it to activity manager 160 for use in evaluating open opportunities. Accordingly, data sources 120 can be sales tracking systems, email systems, and any other data source that stores data relevant to sales that can be mined. Example data sources may include quantitative and qualitative data pertaining to Sales Opportunity Stages, Age, Revenue, and the like regarding the sales opportunity. Additional data may include quantitative data pertaining to Sales Activities such as Total Calls, Emails, Demos, Meetings, and the like. Further quantitative data may include data pertaining to opportunity events: Number of Days in various sales stages, Close Date Changes, Revenue Changes, and the like. Further, quantitative data for each existing customer account may include metric indicators (e.g., key performance indicators) that include information regarding New End User Accounts and Existing Contracts, Provision of Services to End Users, Number of End Users, Not In Good Order (NIGO) Cases and Errors, Service Quality, Response Time, Number of Outstanding Cases, Cases Closed Without Resolution, Service Recovery, Surveys—Survey scores, and so forth. Data for each existing customer account may also include interaction data including Emails (frequency, graph of connections, text of interaction, topics/categories, sentiments expressed), Phone calls, Service Center Requests and Responses, Phone Call Recordings (Speech/Audio), Call Notes, Notes—Activity, Firm, Survey comments, and so forth. Further data for each existing customer may include web logs (pages visited, errors, performance, time outs, activity logs, and so forth) as well as social media activities.

In use, current opportunities can be identified for analysis by system 100. The system 100 classifies the opportunities, identifies the opportunities classified as losing or likely to lose, and uses a difference calculation and simulation search to generate a recommendation for the losing opportunity to become a winning opportunity.

Classifying the Opportunities

Opportunities are identified or classified from working memory 175 and episodic memory 170 to be at risk of loss or on track to winning along with a what-if list of multiple shortest paths to improving the state of the opportunity through the deterministic finite automata.

Email messages can be analyzed by semantic analysis engine 140 and inference engine 145 to identify a sentiment associated with the customer for the open opportunities. The email messages may be obtained via working memory 175 or episodic memory 170 from native system 195 or the sales representatives' user interfaces including the sidebar 185. Sentiment can be determined based on linguistic analysis of email messages from the customers using word embeddings from publicly available corpuses and training on local data. Further, information regarding the state of the opportunity can be used to predict a sentiment of the customer. As an example, if the customer continuously moves the closing date out, the customer may be unhappy with some portion of the deal. As another example, if the customer has increased the number of units for purchase in the deal, the customer may be excited and/or happy about the deal. Alternatively, a sense of urgency may be identified if the customer contacts the salesperson often and/or has moved the closing date in (closer in time).

After analyzing the current opportunities for sentiment, the current opportunities can be analyzed for intent identification by the action recognizer 166 in activity manager 160. Based on the sequence of actions in the current opportunities, similar opportunities can be identified in the historical data and in the open opportunities from data sources 120 by smart search and navigation engine 135. Action recognizer 166 can group the opportunities into multi-dimensional neighborhoods based on, for example, Mahalanobis distance-based extremity driven normalized measures on the multi-dimensional distributions. For example, a similar opportunity can be based on the size of the deal, the timing of the deal, one or more products involved in the deal, or similarity of activities in the deals.

Based on the historical data and data about the opportunity, a score can be generated for pending opportunities in the sales pipeline. In some embodiments, once similar opportunities are identified, the outcomes of the similar opportunities can be used to identify metrics to be used to analyze the current opportunity. For example, the sentiment identified in the current deal can be a metric (i.e., variable). The timing of the deal can be a metric. The products involved in the deal can be a metric. The various activities of the deal can be metrics. Each of the identified metrics can be weighted based on the historical data analysis. The weighted metrics can be used to calculate a score for the opportunity. The score can be an indicator of the probability of a successful closing of the opportunity. This score can be used to classify the opportunity as a winning or losing opportunity. The score may have a temporal and variable driven weighting based on long range and short range order calculated through multi-variate nonstationary time series models with attention, including but not limited to long short term memory based models.

For example, changes to the opportunity can indicate whether the opportunity is at risk. If the number of units being sold increases, that can indicate the opportunity is not at risk. If the number of units decreases or keeps decreasing, that can indicate the opportunity is at risk. Further, moving the closing date can indicate a problem or at risk opportunity (if it moves out or keeps moving out). If, however, the opportunity close date moves in, that may indicate the opportunity is not at risk.

Classifying opportunities into a losing or winning category is based on the score assigned to each opportunity. The score is calculated using input from multiple variables including but not limited to derived and compounded variables and indicators from emails, calls, meetings, tasks, revenue forecast changes, and the like. Similarity of opportunities and distance between opportunities are based on the size of the deal, the timing of the deal, one or more products involved in the deal, or similarity of activities in the deal. Variables are transformed non-linearly to forms relevant to the science of the problem of opportunity scoring with a numerical score of 0-10. For example, text and speech may be converted through natural language processing (“NLP”) to sentiment by a NLP engine including word embeddings based models to feed to the semantic analysis engine 140 using a normalized standard deviation-based score of 0-10 (or any other suitable scale including, for example 0-20, 1-100, or the like), where 0 is negative and 10 is positive. In some embodiments, the score may be directly displayed to the user for different variables, so that the user may know how much worse or better each case is with respect to other local opportunities using, for example, explanations based on locally interpretable model interpretations and Shapley values.

Transforming the variables includes generating a Common Multi-Dimensional Space of 0-10 scores to enable common distance measures. Action recognizer 116 chooses the most significant factors in each neighborhood dynamically by creating local linear surrogate models on top of the original model. Thus, each neighborhood has its own dimensionality. In this way, opportunities are segmented and the solution resolves the challenge of large multi-dimensional vectors falling on the surface of the hypersphere. This Common Multi-Dimensional Spaceenables common distance measures because each neighborhood represents a normalized distance based locality. Higher weightage may be given to closer points when local searches are performed and may use local linear surrogate models for explanations.

To create the common multi-dimensional space, all the 180+ variables listed in Table 1, for example, may be accessed from the CRM databases, in the context of the ontology knowledge base 105. All categorical variables can be converted using entropy encoding to replace each categorical variable with a probability of its occurrence in the dataset using semantic analysis engine 140. Natural language text, speech, and emails, are converted to create a vector of the top ten positive and top ten negative utterances, and their associated named entities for each episodic memory instance for each event in each opportunity stage. A z-score is calculated for each sentiment score over the entire population of opportunities. The z-scores are assigned to the vector elements and used to find the maximal positive and negative z-scores as separate column scores for a particular row of our data.

The system may partition the data into training, validation, and test sets using, for example, standard sampling techniques that oversample low frequency instances while adding stochastic noise components to the independent variables. The system may also train a non-linear model such as an AdaBoost or XGBoost for overall top-level classification by global or non-sequential KPIs/metrics and by taking several variables as the encoded output of the sequential steps in an opportunity using long short term memory. The result is an opportunity scoring model.

The opportunity scoring model is applied to the opportunities to generate the score for each opportunity. As such, the locally highly relevant variables for each opportunity are used to generate the score for the opportunity. The scores can then be used to classify the opportunities into a winning or losing classification. In some embodiments, the classification may include more granularity of, for example, losing, winning, and possible. For example, using the 0-10 scale, any opportunity with a score below 6 may be classified as losing, meaning that the likelihood of the opportunity successfully closing is low or unlikely. Any opportunity with a score between 6 and 8 may be classified as possible, meaning that the likelihood of the opportunity successfully closing is medium or possible. Any opportunity with a score of 9 or 10 may be classified as winning, meaning that the likelihood of the opportunity successfully closing is high or very likely.

Calculate Distances for Losing Opportunities to Become Winning Opportunities

If the opportunity is identified as at risk for not successfully closing (e.g., having a classification of lose or possible, or having a score of less than 7), the goal of the system 100 is to generate an ordered list of shortest paths each including a sequence of the next best actions as a recommendation to the user to help the salesperson move the at-risk opportunity to a better state with a higher likelihood of success. The next best action information can be generated based on similar opportunities that closed successfully, for example, and may also be generated based on the model simulation to find the shortest path to a winning classification. Before generating the recommendation, distances between the losing opportunity and winning opportunities with similar characteristics are calculated.

In some embodiments, another step in implementing the analysis may include finding the shortest path to change the classification of the opportunity to Win (from Loss or Possible) or explain why an opportunity is not working out. In some embodiments a what-if simulation on a set of the shortest paths is used to find one-two actions with the largest change in velocity/direction/magnitude of distribution variation.

In some embodiments, for the simulation search, variables that are directly influenced by decision-makers are used to limit the search space dramatically. Such limitation gives directly actionable intelligence as it pre-identifies what variables can actually be changed versus others that may be hidden or derived variables, creating a knowledge-driven and data-driven intelligent system. In some embodiments, since linear models give limited precision and recall, neural network based black-box models are used. Abductive reasoning is used to explain the current state of the opportunity and to obtain rates of change of the most important variables at the location of that opportunity in the multi-dimensional space using a local search. To simulate or approximate abductive reasoning, a local search (defined by the normalized distance described above, that includes a configurable number of Wins or Losses) along the greatest gradient to positive or negative change to find the top five shortest paths by perturbing current states to the nearest opportunity classified as a Win by the original neural network based model, with cost of change, along with Bayesian probabilities of success and probability of activation/occurrence/success of each step in the path based on distributions of past data on the opportunities. Neither a linear nor a black-box model by itself gives the shortest path (a model is, in effect, comprised of tensors of complex functions)—simulations (e.g., what-if simulations) enable search for the path. The simplest path may be a vector of exact changes in the variables needed to change classification, or a graph of ordered changes in variables needed. The Metropolis-Hastings algorithm is a possible choice for such multi-variate distributions. Distribution parameters of the predictor variables in the local area from the local surrogate models are obtained and used to simulate a version from which to pick variable values. The boundary condition may be determined by the hypersphere of the boundary conditions derived from the extrema of, for example, five to ten (5-10) closest known wins/losses.

Thus, each neighborhood of each opportunity has its own dimensionality. This allows the system to segment the opportunities very effectively for each local group of opportunities. The opportunities in each local group can be distinguished by clear differentiation due to changing distances based on variables which are locally important, which would be lost if a multi-dimensional space of all variables were considered, where nearly all points will appear to be on the surface of the multivariate hypershpere making their local distances insignificant, even though those distances are the most significant and drive the changes in the state of the opportunity. For example, in the case of Opportunity A, only seven variables may be shown as important in the local neighborhood, such as Number of High Priority Incidents, Number of New End User Accounts, Number of Existing Contracts, Not In Good Order (NIGO) Cases, number of Service Errors and number of Service Quality Violations. On the other hand, in the case of Opportunity B, another set of seven variables may be more important such as number of Service Quality Escalations, number of Outstanding Unresolved Cases, number of Cases Closed Without Resolution, Service Recovery, Email Frequency Between Individuals Involved in a Deal, Sentiments expressed in each sentence of each email by named entities, and Phone Call Frequency Between Individuals Involved in a Deal. For Opportunity C, yet another set of variables may be more important such as Content of Phone Call Interaction with Automated Speech Recognition (ASR), Sentiments expressed in each utterance of each phone call by named entities, number of Resolved outside SLA, number of Resolved significantly better than SLA, Sentiment in Text of Service Center Responses, Sentiment in Call Notes for Sales and Service Personnel and Sentiment in Text Activity on Service Tickets. The actual number of variables in the local linear models could range from as little as three (3) to more than thirty (30), for example.

Given the above steps, the search space boundaries and dimensions for each case or opportunity is known and a simulation search may be executed to find what can be done to change the opportunity classification. Variables that are directly influenced by decision-makers may be used to limit the scope of the simulation. The result is directly actionable intelligence. For example, for Opportunity A above, the relevant variables may be number of Service Errors and number of Service Quality Violations. In some embodiments, the list may be six or seven variables long. For Opportunity B above, the relevant variables may be number of Outstanding Unresolved Cases, number of Cases Closed Without Resolution, Email Frequency, and Phone Call Frequency. For Opportunity C above, the relevant variables may be number of Resolved outside SLA, number of Resolved significantly better than SLA.

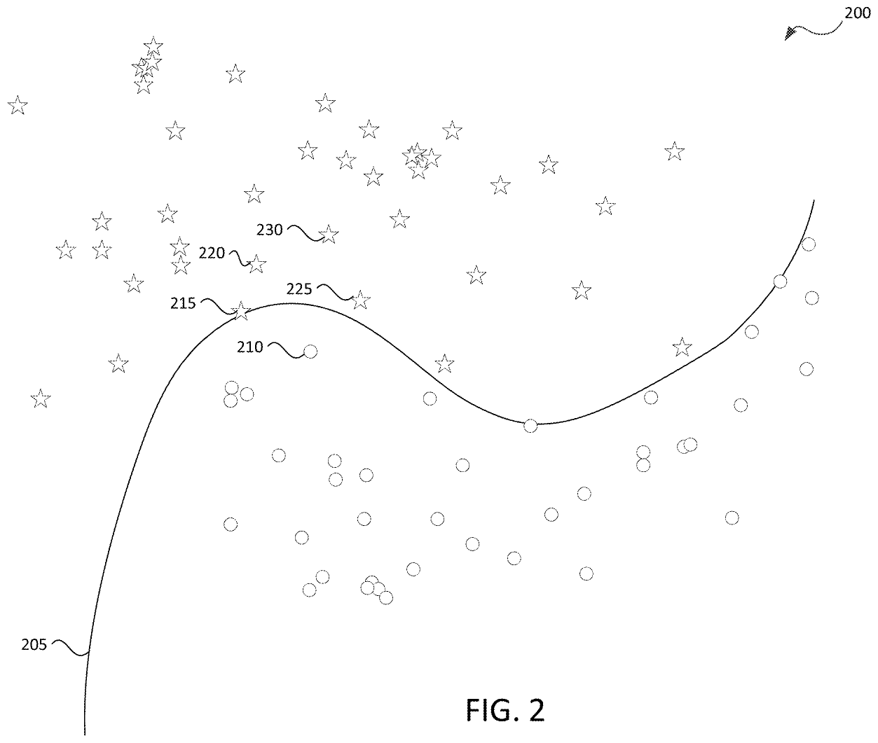

FIG. 2 illustrates an exemplary neighborhood for a variable with an example distribution of opportunities classified as Win or Loss. FIG. 2 is for illustrative purposes to help the reader visualize what a neighborhood may look like and imagine how the distance between opportunities may be calculated in a two-dimensional space. The opportunities classified as a Win are shaped as stars, while the opportunities classified as a Loss are shaped as circles. A Gaussian curve 205 is fit that generally identifies the separation between the two classifications (win versus loss) of opportunities for the relevant variable (e.g., Number of Service Errors, Number of Service Quality Violations, or the like). As described above, the variables can each represent a different dimension, meaning that the system can calculate the distance in a multi-dimensional space having any number of dimensions (variables). Opportunity 210 may be classified as Loss, and Opportunities 215, 220, 225, and 230 may be classified as Win. The simulation search may identify Opportunities 215, 220, 225, and 230 as the four closest opportunities for the relevant variable. The data related to Opportunities 215, 220, 225, and 230 may be used to identify steps the representative handling opportunity 210 may take to change the classification of opportunity 210 from Loss to Win. Opportunities 215, 220, 225, and 230 may be already closed opportunities in some embodiments. In some embodiments, some or all of opportunities 215, 220, 225, and 230 may still be pending.

Generate a Recommendation Based on the Distances

After identifying the related opportunities that closed successfully, the simulation search based on the opportunity scoring models can identify actions that helped the opportunity reach closing, and provide a suggested next best action or ordered list of shortest paths each of which is a sequence of changes required in the variables of importance to an opportunity classified as a Win. An element that enables the algorithm to distinguish the opportunities is the distance measure chosen and the process of limiting the dimensions to be only the local variables of importance through their local derivatives. In some embodiments, the suggested action can be based on the sentiment of the customer. For example, if the customer is identified as unhappy and the machine learning algorithms identify price as a reason for the unhappiness (perhaps based on activities of the customer such as reducing the number of units or stating as much in an email), the next best action suggestion may be a price reduction.

Since linear models give limited precision and recall, original AdaBoost or XGBoost and abductive reasoning may be used to generate the recommendation. As mentioned above, to simulate or approximate abductive reasoning, a local search (defined by normalized distance above, that includes a configurable number of wins or losses) along the greatest gradient to positive or negative change is used to find the top five shortest paths by perturbing states to the nearest known Win or Win classification by original model, with cost of change. An example visual depiction is shown in FIG. 2. Bayesian probabilities of success and probability of activation/occurrence/success of each step in the path based on distributions of past data may be used. For example, returning to the example of Opportunities A, B, and C, for Opportunity A, the path might be that if we have just one more Service Quality Violation, Opportunity will likely close as a Loss, and if we reduce the number of Service Errors and Violations by just 28%, Opportunity A will likely close as a Win. For example, for Opportunity B, the path might be that if there are 11% Outstanding Unresolved Cases or Cases Closed Without Resolution, Opportunity B will close as a Loss no matter how many emails are sent by the representative or phone calls are made by the representative, and if the number of Unresolved Cases and Cases Closed Without Resolution is reduced by 17%, emails and phone calls from the sales representative may be able to change the classification from Loss to Win, and increasing emails and phone calls by the representative by 26% may be sufficient to win the opportunity. For example, for Opportunity C, the path to a Win might be to increase the cases Resolved Significantly Better than SLA by 11% and cut down number of Resolved Outside SLA to Zero. The disclosed system may provide these insights to the user to utilize to convert the at-risk (Loss) opportunity to a Win.

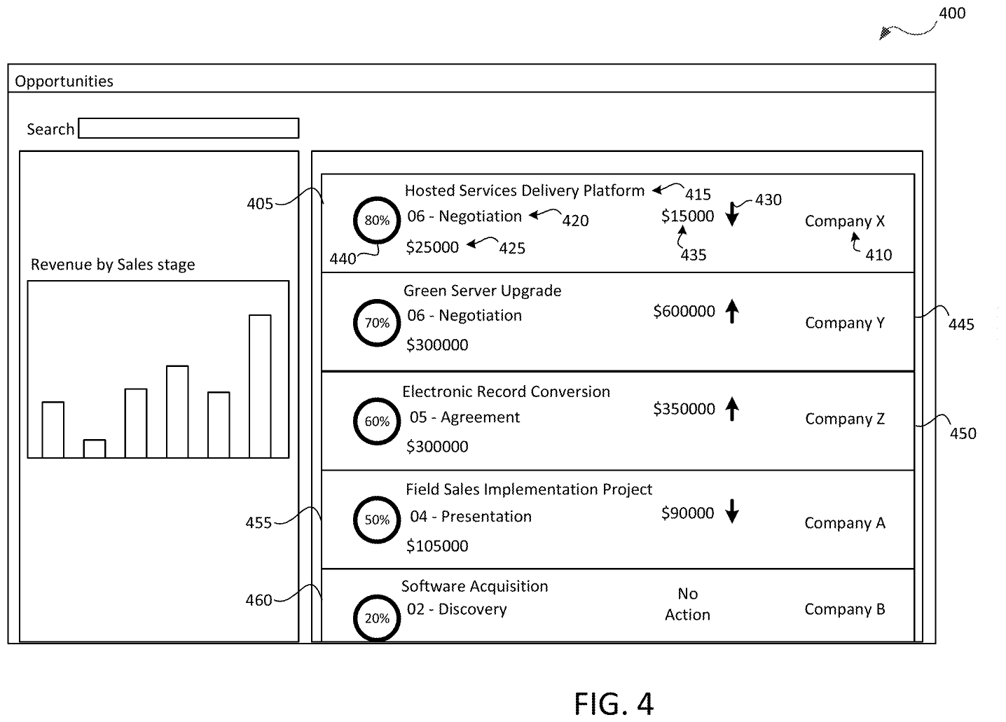

The scoring and next best action information can be provided in a user interface to the sales representatives or in a dashboard type user interface to executives that watch key performance indicators (“KPI”). The information for each opportunity can be tracked and used to generate other KPIs for viewing in the dashboard as well. FIGS. 4, 5, and 6 provide exemplary graphical user interfaces for providing the information.

A representative list of variables that may be used in the models described herein includes those listed in Table 1. As previously described, the variables may be stored in ontology knowledge base 105.

TABLE 1

| | |
|---|---|
| 1. | Opportunity ID |
| 2. | Opportunity Product ID |
| 3. | Opportunity Type |
| 4. | Revenue Type |
| 5. | Sales Stage |
| 6. | Service Incidents |
| 7. | Customer |
| 8. | Location |
| 9. | Date |
| 10. | Product |
| 11. | Product Class |
| 12. | Sales Resource |
| 13. | Industry Class |
| 14. | Opportunity Line Revenue |
| 15. | Close Date Movement |
| 16. | Close Date Movement in Days |
| 17. | Revenue Line Status |
| 18. | Product ID |
| 19. | Product Name |
| 20. | Opportunity Status |
| 21. | number of Stages |
| 22. | Opportunity Age |
| 23. | Opportunity Velocity |
| 24. | Opportunity Revenue |
| 25. | Max Days in Stage |
| 26. | Channel Type |
| 27. | Opportunity Revenue Category |
| 28. | Organization Size |
| 29. | Annual Revenue Category |
| 30. | Number of Employees |
| 31. | Line of Business Code |
| 32. | Sales Method |
| 33. | Opportunity Region |
| 34. | Industry Name |
| 35. | number of Days in Qualification |
| 36. | number of Days in Discovery |
| 37. | number of Days in Building Vision |
| 38. | number of Days in Presentation |
| 39. | number of Days in Agreement |
| 40. | number of Days in Negotiation |
| 41. | Total Activities |
| 42. | Total Calls |
| 43. | Total Demos |
| 44. | Total Meetings |
| 45. | Total Emails |
| 46. | Call Freq Days |
| 47. | Demo Freq Days |
| 48. | Meeting Freq Days |
| 49. | Email Freq Days |
| 50. | number of Activities in Qualification |
| 51. | number of Activities in Discovery |
| 52. | number of Activities in Building Vision |
| 53. | number of Activities in Presentation |
| 54. | number of Activities in Agreement |
| 55. | number of Activities in Negotiation |
| 56. | number of Calls in Qualification |
| 57. | number of Calls in Discovery |
| 58. | number of Calls in Building Vision |
| 59. | number of Calls in Presentation |
| 60. | number of Calls in Agreement |
| 61. | number of Calls in Negotiation |
| 62. | number of Demos in Qualification |
| 63. | number of Demos in Discovery |
| 64. | number of Demos in Building Vision |
| 65. | number of Demos in Presentation |
| 66. | number of Demos in Agreement |
| 67. | number of Demos in Negotiation |
| 68. | number of Meetings in Qualification |
| 69. | number of Meetings in Discovery |
| 70. | number of Meetings in Building Vision |
| 71. | number of Meetings in Presentation |
| 72. | number of Meetings in Agreement |
| 73. | number of Meetings in Negotiation |
| 74. | number of Emails in Qualification |
| 75. | number of Emails in Discovery |
| 76. | number of Emails in Building Vision |
| 77. | number of Emails in Presentation |
| 78. | number of Emails in Agreement |
| 79. | number of Emails in Negotiation |
| 80. | Call Frequency Days in Qualification |
| 81. | Call Frequency Days in Discovery |
| 82. | Call Frequency Days in Building Vision |
| 83. | Call Frequency Days in Presentation |
| 84. | Call Frequency Days in Agreement |
| 85. | Call Frequency Days in Negotiation |
| 86. | Demo Frequency Days in Qualification |
| 87. | Demo Frequency Days in Discovery |
| 88. | Demo Frequency Days in Building Vision |
| 89. | Demo Frequency Days in Presentation |
| 90. | Demo Frequency Days in Agreement |
| 91. | Demo Frequency Days in Negotiation |
| 92. | Meeting Frequency Days in Qualification |
| 93. | Meeting Frequency Days in Discovery |
| 94. | Meeting Frequency Days in Building Vision |
| 95. | Meeting Frequency Days in Presentation |
| 96. | Meeting Frequency Days in Agreement |
| 97. | Meeting Frequency Days in Negotiation |
| 98. | Email Frequency Days in Qualification |
| 99. | Email Frequency Days in Discovery |
| 100. | Email Frequency Days in Building Vision |
| 101. | Email Frequency Days in Presentation |
| 102. | Email Frequency Days in Agreement |
| 103. | Email Frequency Days in Negotiation |
| 104. | number of Close Date Changes |
| 105. | Close Date Change Days |
| 106. | number of Revenue Changes |
| 107. | Revenue Change % |
| 108. | number of Owner Changes |
| 109. | number of Contact Changes |
| 110. | number of Close Date Changes in Qualification |
| 111. | number of Close Date Changes in Discovery |
| 112. | number of Close Date Changes in Building Vision |
| 113. | number of Close Date Changes in Presentation |
| 114. | number of Close Date Changes in Agreement |
| 115. | number of Close Date Changes in Negotiation |
| 116. | Close Date Change Days in Qualification |
| 117. | Close Date Change Days in Discovery |
| 118. | Close Date Change Days in Building Vision |
| 119. | Close Date Change Days in Presentation |
| 120. | Close Date Change Days in Agreement |
| 121. | Close Date Change Days in Negotiation |
| 122. | number of Revenue Changes in Qualification |
| 123. | number of Revenue Changes in Discovery |
| 124. | number of Revenue Changes in Building Vision |
| 125. | number of Revenue Changes in Presentation |
| 126. | number of Revenue Changes in Agreement |
| 127. | number of Revenue Changes in Negotiation |
| 128. | Revenue Change % in Qualification |
| 129. | Revenue Change % in Discovery |
| 130. | Revenue Change % in Building Vision |
| 131. | Revenue Change % in Presentation |
| 132. | Revenue Change % in Agreement |
| 133. | Revenue Change % in Negotiation |
| 134. | number of Owner Changes in Qualification |
| 135. | number of Owner Changes in Discovery |
| 136. | number of Owner Changes in Building Vision |
| 137. | number of Owner Changes in Presentation |
| 138. | number of Owner Changes in Agreement |
| 139. | number of Owner Changes in Negotiation |
| 140. | number of Contact Changes in Qualification |
| 141. | number of Contact Changes in Discovery |
| 142. | number of Contact Changes in Building Vision |
| 143. | number of Contact Changes in Presentation |
| 144. | number of Contact Changes in Agreement |
| 145. | number of Contact Changes in Negotiation |
| 146. | High Priority Incidents |
| 147. | Medium Priority Incidents |
| 148. | Low Priority Incidents |
| 149. | New End User Accounts |
| 150. | Size of New Accounts |
| 151. | Number of Existing Contracts |
| 152. | Size of Existing Contracts |
| 153. | number of Services Provisioned to End Users |
| 154. | number of End Users |
| 155. | Not In Good Order (NIGO) Cases |
| 156. | number of Service Errors |
| 157. | number of Service Quality Violations |
| 158. | number of Service Quality Escalations |
| 159. | Distribution of Response Time by Service Ticket Type |
| 160. | number of Outstanding Unresolved Cases |
| 161. | number of Cases Closed Without Resolution, Service Recovery |
| 162. | Survey scores |
| 163. | Survey comments, topics and sentiments |
| 164. | Email Frequency Between Individuals Involved in a Deal |
| 165. | Live Graph of connections with strength of connections |
| | in each edge |
| 166. | Text of email interaction |
| 167. | Specific topics/categories in emails |
| 168. | Sentiments expressed in each sentence of each email by |
| | named entities |
| 169. | Phone Call Frequency Between Individuals Involved in a Deal |
| 170. | Phone Call Live Graph of connections with strength of connections |
| | in each edge |
| 171. | Content of Phone Call Interaction with Automated Speech |
| | Recognition (ASR) |
| 172. | Specific topics/categories in Phone Calls |
| 173. | Sentiments expressed in each utterance of each phone call by |
| | named entities |
| 174. | number of Service Center Requests |
| 175. | number of Resolved within SLA |
| 176. | number of Resolved outside SLA |
| 177. | number of Resolved significantly better than SLA |
| 178. | Text of Service Center Responses |
| 179. | Call Notes for Sales and Service Personnel |
| 180. | Text Activity on Service Tickets |
| 181. | Web Logs - Pages visited |
| 182. | Web Logs - Errors |
| 183. | Web Logs - Performance |
| 184. | Web Logs - Time Outs |
| 185. | Web Logs - Activity Logs |
| 186. | Signal on Social Media - Twitter, Facebook, LinkedIn |

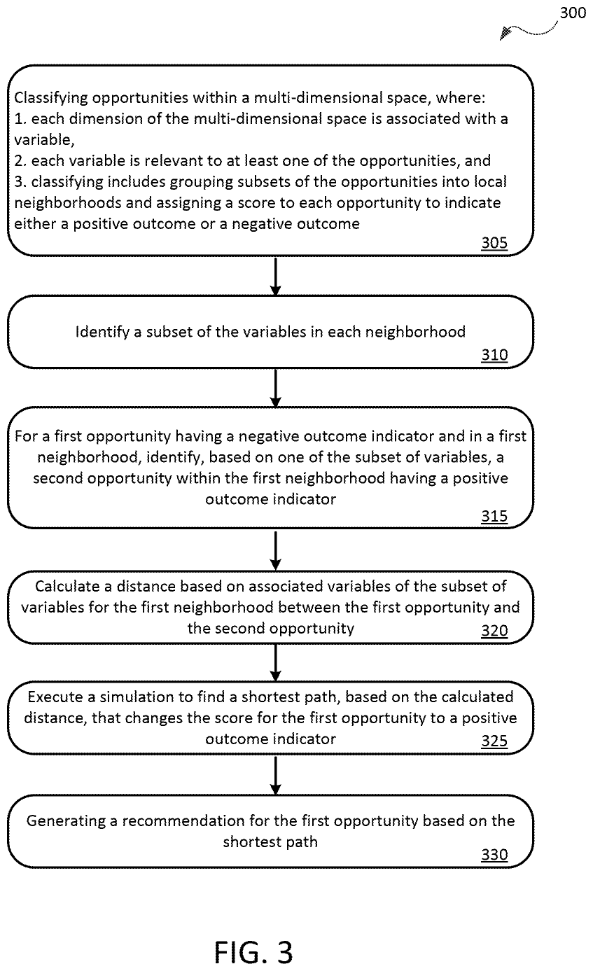

FIG. 3 illustrates an example method 300 for classifying opportunities and generating recommendations based on the classifications. Method 300 may be performed by, for example, system 100 as described with respect to FIG. 1. Method 300 may begin with classifying opportunities within a multi-dimensional space at step 305. Each dimension of the multi-dimensional space is associated with a variable, and each variable is relevant to at least one of the opportunities being classified. For example, any of the variables identified in Table 1 may be a variable used for a dimension in the multi-dimensional space. Classifying the opportunities also includes grouping subsets of the opportunities into local neighborhoods and assigning one of two values (Win or Loss) to each opportunity to indicate either a positive outcome (Win) or a negative outcome (Loss).

At step 310, a subset of the variables in each neighborhood are identified. The identified subset of variables are the locally important variables. There may be two to seven (for example) variables identified. The process of identifying these variables may be, for example, to find local derivatives of the deep learning models identified earlier for opportunity scoring, and determining which derivatives have the largest positive or negative statistically significant impact to change the state of the opportunity through a search through the local space as identified by the extrema of the boundary conditions of the top n similar opportunities as determined by a Mahalanobis distance measure on normalized variables. After identifying which variables have the largest impact, the search space may be limited to a multi-dimensional space consisting only of those identified variables. These variables form the local multi-dimensional subset.

At step 315, for a first opportunity having the negative outcome indicator (classified as a Loss) in a first neighborhood, a second opportunity having the positive outcome indicator is identified based on one of the subset of variables. A search may be performed to identify the first opportunity. The simulation search is based on one or more of the variables identified in step 310. For example, the search may identify the top two to five opportunities that are classified as a Win that have the highest gradient change between itself and the opportunity classified as a Loss. The gradient of the opportunity scoring model can be calculated based on the identified subset of variables (the locally important variables) and the search is performed by moving along the direction of maximal positive gradient change. In other words, the search is constrained to move along the maximal gradient in opportunity score. Because the search is liable to get stuck in local minima around the opportunity, an adaptive stochastic gradient ascent is used that is akin to combining gradient ascent with simulated annealing for the purpose of taking the search broader within the boundary conditions identified by the extrema of the variables of local importance. This approach has the drawback of being limited by the local neighborhood of the opportunity. If all opportunities around the current opportunity are at a risk of loss or are classified as a losing opportunity, the size of the neighborhood is increased to include at least one opportunity classified as a Win.

At step 320, a distance is calculated between the opportunity classified as a Loss and those classified as a Win identified in step 315. The distance is calculated based on the identified subset of variables. A multi-dimensional vector may be calculated for the distance in some embodiments.

At step 325, a simulation is executed to find a shortest path, based on the calculated distance at step 320, that changes the score for the first opportunity to a positive outcome indicator. For example, the multi-dimensional Manhattan distance can be calculated between the current opportunity and the nearest winning opportunity as the shortest path.

At step 330, the recommendation is generated for the opportunity classified as a Loss based on the shortest path identified in step 325. The behaviors identified in the Winning opportunities relevant to the locally important variables are identified and used to generate the recommendation. For example, if one of the subset of variables (locally important variables) is Number of Calls in Agreement, and the representative in the identified closest Winning opportunities made a minimum of fifteen calls, but the representative in the Losing opportunity has only made two calls, the recommendation may be to call once per week to increase the number of calls. In some embodiments, the recommendation may include the type of call (e.g., status update, check-in, or the like).

FIG. 4 illustrates an example user interface 400 for providing information for each opportunity. For example, the first opportunity 405 is 80% complete as shown by indicator 440. The information provided for opportunity 405 includes that the deal is with Company X as indicated at 410. The opportunity 405 is for the hosted services delivery platform as indicated at 415. The opportunity 405 is in the negotiation stage as indicated at 420. The opportunity 405 has a value of $25000 as indicated at 425. The arrow 430 indicates that the value of the deal has decreased by the amount $15000 as shown at 435. The decrease in value may indicate the health of the deal is not high. Other opportunities 445, 450, 455, and 460 may be displayed with similar information for each.

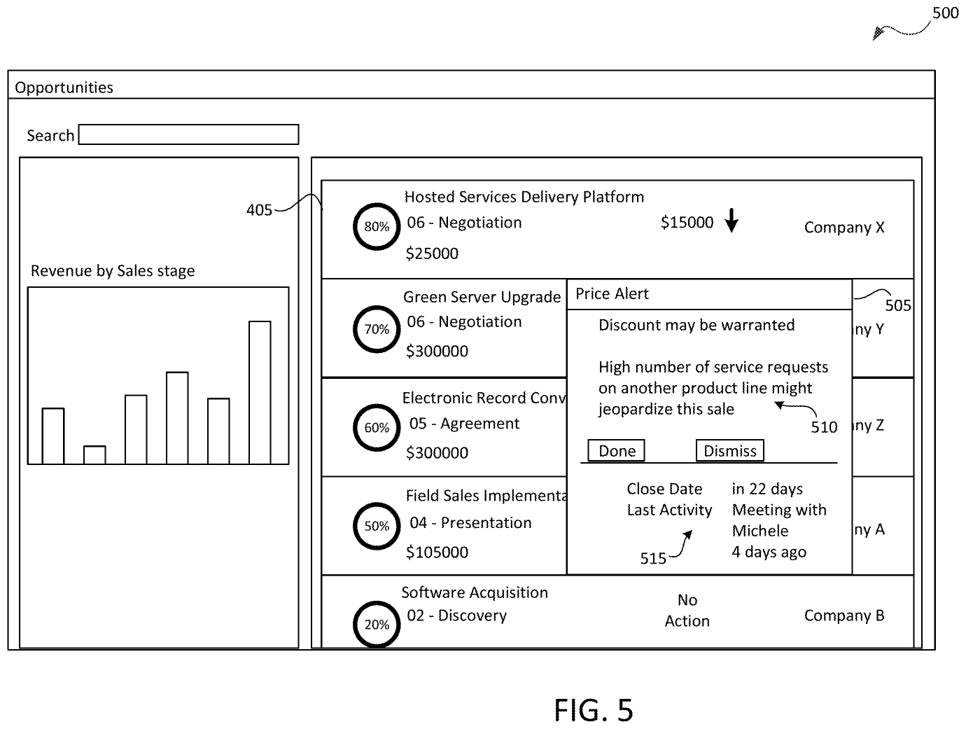

FIG. 5 is an example of a user interface 500 for providing a next best action recommendation. The user may click the first opportunity 405 to obtain more information. The Price alert 505 can suggest that a discount may be warranted to help the opportunity close. For example, one locally relevant variable may be price, another may be Revenue Change Percent, and another may be Changes in Close Date. Opportunity 405 may have had the close date changed (not shown) from August 1 to September 15, for example, and the revenue decreased by 37.5% based on a decrease of $15000 with a new deal value of $25000. Accordingly, the system 100 may identify that the close date change and price decrease indicates that opportunity 405 is at risk. Further, another locally important variable may be Number of Service Requests on other products for this customer. In other words, the customer may be unhappy with the number of service requests needed for other products they have purchased. Accordingly, price alert 505 may indicate that price decrease (discount) may be warranted and note that the high number of service requests on another product line may jeopardize this sale at 510. The information also provides a reasoning for suggesting the price discount—because a high number of service requests on another product line might jeopardize this sale. Recent activities for opportunity 405 may also be reported at 515 including the upcoming closing date and last activity recorded.

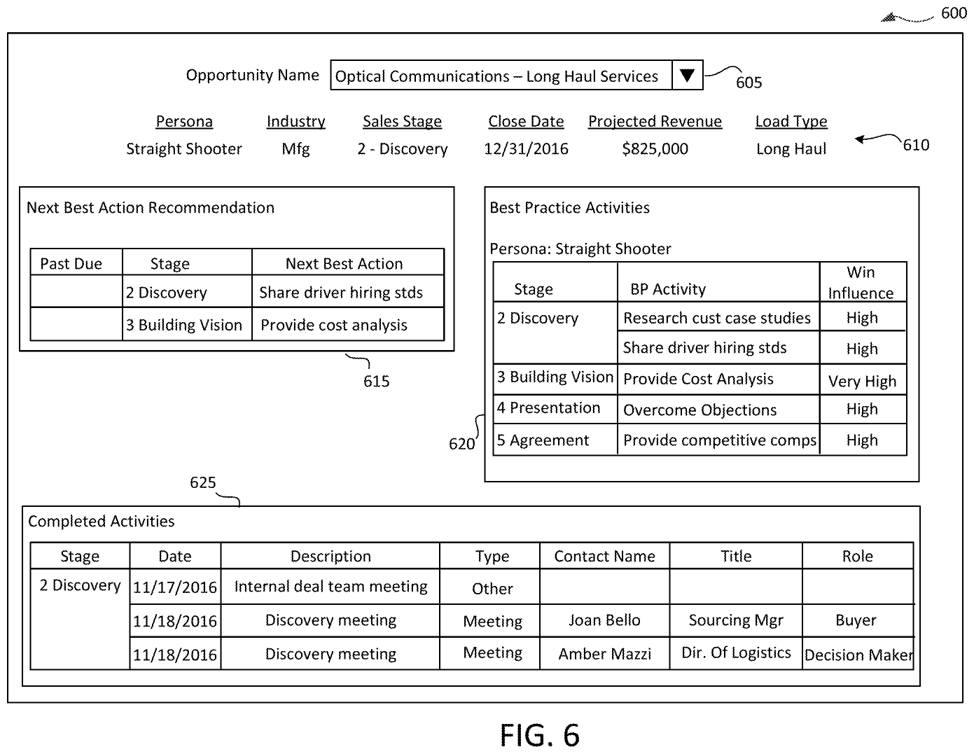

FIG. 6 provides an example user interface 600 for providing next best action recommendations for deals/opportunities. A specific opportunity 605 may be identified, in this example Optical Communications—Long Haul Services. The opportunity 605 may have any suitable name given by the sales representative or company. The opportunity 605 may be selected from a drop-down menu of opportunities. The user interface 600 may provide information for the opportunity 605 including the persona type of the primary contact (e.g., a straight shooter), the type of industry the opportunity 605 falls into (e.g., manufacturing), the stage of the opportunity 605 (e.g., Discovery, which is the second stage of the deal flow process), the closing date that is currently set or targeted (e.g., Dec. 31, 2016), the projected revenue from the opportunity 605 (e.g., $825,000), and the load type (e.g., long haul). In this example, the opportunity may be a delivery of goods that is a long haul (e.g., cross-country) delivery.

The next best recommendation box 615 for shortest series of steps to a winning classification may include steps to perform at one or more stages of the opportunity 605 to improve the state of the opportunity 605. For example, at Discovery, stage 2, the sales representative should share driver hiring standards with the potential client. Knowing what standards are used to hire drivers may give the potential client a sense of security that the deal will complete and be delivered timely and safely. This knowledge may be known to be important to help an opportunity proceed from stage 2 to stage 3, building vision. More specifically, for this type of client (e.g., a straight shooter), driver hiring standards may be particularly helpful, and this may be determined based on using system 100 to classify the opportunities, and analyzing the activities of winning opportunities at stage 2 that have similar characteristics including the type of deal, the size of the deal, the type of contact (e.g., straight shooter), and so forth.

The Best practice activities box 620 may provide known best practices for clients of any specific type. In the example, the potential client has been classified as a straight shooter persona. This classification may be determined by the sales representative and manually entered. In some embodiments, the behaviors and communications of the potential client can be analyzed and modeled to classify the type of persona the potential client has. Once the persona is identified, known winning opportunities for the persona type can be analyzed to find patterns of successful activities that improve the chances for that opportunity to close successfully. For this example, best practice activities box 620 provides recommendations at stages of the deal flow including at stage 2 to research customer case studies and share driver hiring standards. The amount of effect the activity may have on the deal may also be provided to encourage the sales representative to take such actions. For example, researching customer case studies has a high impact on the deal at the Discovery stage 2. As another example, providing a cost analysis at the Building Vision stage 3 has a very high influence on the success of the opportunity 605.

The completed activities box 625 may provide a listing of reported activities engaged in by the sales representative or sales team for this particular opportunity 605. The completed activities box 625 may help the sales representative remember key activities as well as provide reporting to the remainder of the team and management. Additionally, this information may be used to analyze this opportunity 605 as well as other opportunities.

FIG. 7 depicts a simplified diagram of a distributed system 700 for implementing an embodiment. In the illustrated embodiment, distributed system 700 includes one or more client computing devices 702, 704, 706, and 708, coupled to a server 712 via one or more communication networks 710. Clients computing devices 702, 704, 706, and 708 may be configured to execute one or more applications.

In certain embodiments, server 712 may provide services or software applications that can include non-virtual and virtual environments. In some embodiments, these services may be offered as web-based or cloud services, such as under a Software as a Service (SaaS) model to the users of client computing devices 702, 704, 706, and/or 708. Users operating client computing devices 702, 704, 706, and/or 708 may in turn utilize one or more client applications to interact with server 712 to utilize the services provided by these components.

In the configuration depicted in FIG. 7, server 712 may include one or more components 718, 720 and 722 that implement the functions performed by server 712. These components may include software components that may be executed by one or more processors, hardware components, or combinations thereof. It should be appreciated that various different system configurations are possible, which may be different from distributed system 700. The embodiment shown in FIG. 7 is thus one example of a distributed system for implementing an embodiment system and is not intended to be limiting.

Users may use client computing devices 702, 704, 706, and/or 708 to execute one or more applications, which may generate one or more storage requests that may then be serviced in accordance with the teachings of this disclosure. A client device may provide an interface that enables a user of the client device to interact with the client device. The client device may also output information to the user via this interface. Although FIG. 7 depicts only four client computing devices, any number of client computing devices may be supported.

The client devices may include various types of computing systems such as portable handheld devices, general purpose computers such as personal computers and laptops, workstation computers, wearable devices, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux or Linux-like operating systems such as Google Chrome™ OS) including various mobile operating systems (e.g., Microsoft Windows Mobile®, iOS®, Windows Phone®, Android™, BlackBerry®, Palm OS®). Portable handheld devices may include cellular phones, smartphones, (e.g., an iPhone®), tablets (e.g., iPad®), personal digital assistants (PDAs), and the like. Wearable devices may include Google Glass® head mounted display, and other devices. Gaming systems may include various handheld gaming devices, Internet-enabled gaming devices (e.g., a Microsoft Xbox® gaming console with or without a Kinect® gesture input device, Sony PlayStation® system, various gaming systems provided by Nintendo®, and others), and the like. The client devices may be capable of executing various different applications such as various Internet-related apps, communication applications (e.g., E-mail applications, short message service (SMS) applications) and may use various communication protocols.

Network(s) 710 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 710 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 712 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. Server 712 can include one or more virtual machines running virtual operating systems, or other computing architectures involving virtualization such as one or more flexible pools of logical storage devices that can be virtualized to maintain virtual storage devices for the server. In various embodiments, server 712 may be adapted to run one or more services or software applications that provide the functionality described in the foregoing disclosure.

The computing systems in server 712 may run one or more operating systems including any of those discussed above, as well as any commercially available server operating system. Server 712 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, Sybase®, IBM® (International Business Machines), and the like.

In some implementations, server 712 may include one or more applications to analyze and consolidate data feeds and/or event updates received from users of client computing devices 702, 704, 706, and 708. As an example, data feeds and/or event updates may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 712 may also include one or more applications to display the data feeds and/or real-time events via one or more display devices of client computing devices 702, 704, 706, and 708.

Distributed system 700 may also include one or more data repositories 714, 716. These data repositories may be used to store data and other information in certain embodiments. For example, one or more of the data repositories 714, 716 may be used to store information such as data used to analyze and display in the user interface/dashboard/CXO cockpit. Data repositories 714, 716 may reside in a variety of locations. For example, a data repository used by server 712 may be local to server 712 or may be remote from server 712 and in communication with server 712 via a network-based or dedicated connection. Data repositories 714, 716 may be of different types. In certain embodiments, a data repository used by server 712 may be a database, for example, a relational database, such as databases provided by Oracle Corporation® and other vendors. One or more of these databases may be adapted to enable storage, update, and retrieval of data to and from the database in response to SQL-formatted commands.

In certain embodiments, one or more of data repositories 714, 716 may also be used by applications to store application data. The data repositories used by applications may be of different types such as, for example, a key-value store repository, an object store repository, or a general storage repository supported by a file system.

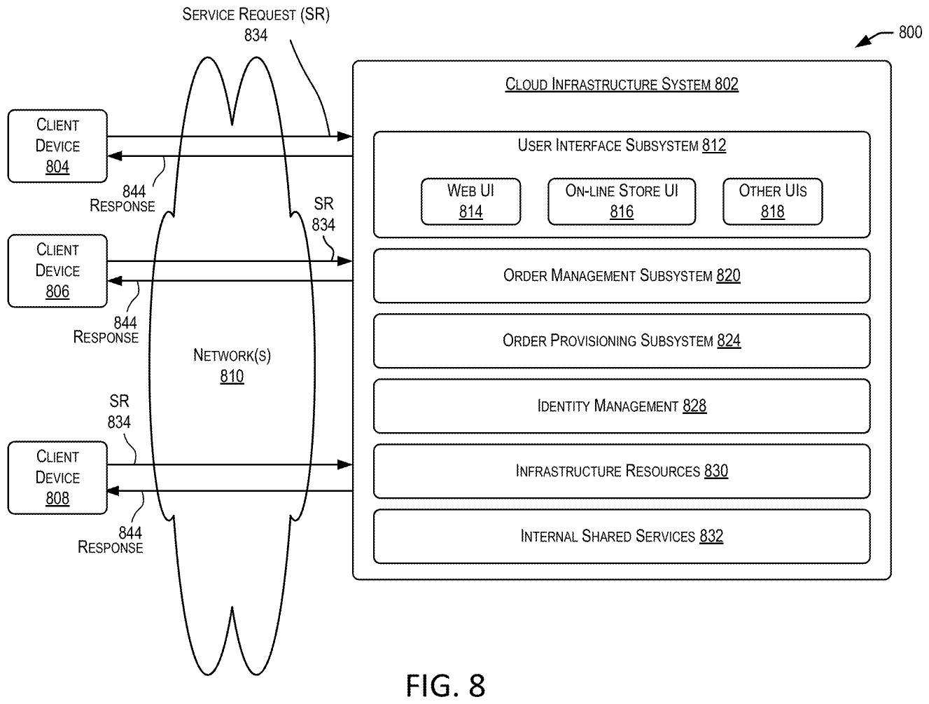

In certain embodiments, the storage-related functionalities described in this disclosure may be offered as services via a cloud environment. FIG. 8 is a simplified block diagram of a cloud-based system environment in which various storage-related services may be offered as cloud services, in accordance with certain embodiments. In the embodiment depicted in FIG. 8, cloud infrastructure system 802 may provide one or more cloud services that may be requested by users using one or more client computing devices 804, 806, and 808. Cloud infrastructure system 802 may comprise one or more computers and/or servers that may include those described above for server 712. The computers in cloud infrastructure system 802 may be organized as general purpose computers, specialized server computers, server farms, server clusters, or any other appropriate arrangement and/or combination.

Network(s) 810 may facilitate communication and exchange of data between clients 804, 806, and 808 and cloud infrastructure system 802. Network(s) 810 may include one or more networks. The networks may be of the same or different types. Network(s) 810 may support one or more communication protocols, including wired and/or wireless protocols, for facilitating the communications.

The embodiment depicted in FIG. 8 is only one example of a cloud infrastructure system and is not intended to be limiting. It should be appreciated that, in some other embodiments, cloud infrastructure system 802 may have more or fewer components than those depicted in FIG. 8, may combine two or more components, or may have a different configuration or arrangement of components. For example, although FIG. 8 depicts three client computing devices, any number of client computing devices may be supported in alternative embodiments.

The term cloud service is generally used to refer to a service that is made available to users on demand and via a communication network such as the Internet by systems (e.g., cloud infrastructure system 802) of a service provider. Typically, in a public cloud environment, servers and systems that make up the cloud service provider's system are different from the customer's own on-premise servers and systems. The cloud service provider's systems are managed by the cloud service provider. Customers can thus avail themselves of cloud services provided by a cloud service provider without having to purchase separate licenses, support, or hardware and software resources for the services. For example, a cloud service provider's system may host an application, and a user may, via the Internet, on demand, order and use the application without the user having to buy infrastructure resources for executing the application. Cloud services are designed to provide easy, scalable access to applications, resources and services. Several providers offer cloud services. For example, several cloud services are offered by Oracle Corporation® of Redwood Shores, Calif., such as middleware services, database services, Java cloud services, and others.

In certain embodiments, cloud infrastructure system 802 may provide one or more cloud services using different models such as under a Software as a Service (SaaS) model, a Platform as a Service (PaaS) model, an Infrastructure as a Service (IaaS) model, and others, including hybrid service models. Cloud infrastructure system 802 may include a suite of applications, middleware, databases, and other resources that enable provision of the various cloud services.

A SaaS model enables an application or software to be delivered to a customer over a communication network like the Internet, as a service, without the customer having to buy the hardware or software for the underlying application. For example, a SaaS model may be used to provide customers access to on-demand applications that are hosted by cloud infrastructure system 802. Examples of SaaS services provided by Oracle Corporation® include, without limitation, various services for human resources/capital management, customer relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware and networking resources) to a customer as a cloud service to provide elastic compute and storage capabilities. Various IaaS services are provided by Oracle Corporation®.

A PaaS model is generally used to provide, as a service, platform and environment resources that enable customers to develop, run, and manage applications and services without the customer having to procure, build, or maintain such resources. Examples of PaaS services provided by Oracle Corporation® include, without limitation, Oracle Java Cloud Service (JCS), Oracle Database Cloud Service (DBCS), data management cloud service, various application development solutions services, and others.

Cloud services are generally provided on an on-demand self-service basis, subscription-based, elastically scalable, reliable, highly available, and secure manner. For example, a customer, via a subscription order, may order one or more services provided by cloud infrastructure system 802. Cloud infrastructure system 802 then performs processing to provide the services requested in the customer's subscription order. Cloud infrastructure system 802 may be configured to provide one or even multiple cloud services.

Cloud infrastructure system 802 may provide the cloud services via different deployment models. In a public cloud model, cloud infrastructure system 802 may be owned by a third party cloud services provider and the cloud services are offered to any general public customer, where the customer can be an individual or an enterprise. In certain other embodiments, under a private cloud model, cloud infrastructure system 802 may be operated within an organization (e.g., within an enterprise organization) and services provided to customers that are within the organization. For example, the customers may be various departments of an enterprise such as the Human Resources department, the Payroll department, etc. or even individuals within the enterprise. In certain other embodiments, under a community cloud model, the cloud infrastructure system 802 and the services provided may be shared by several organizations in a related community. Various other models such as hybrids of the above mentioned models may also be used.

Client computing devices 804, 806, and 808 may be of different types (such as devices 702, 704, 706, and 708 depicted in FIG. 7) and may be capable of operating one or more client applications. A user may use a client device to interact with cloud infrastructure system 802, such as to request a service provided by cloud infrastructure system 802.

In some embodiments, the processing performed by cloud infrastructure system 802 may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. The data used for this analysis may include structured data (e.g., data stored in a database or structured according to a structured model) and/or unstructured data (e.g., data blobs (binary large objects)).

As depicted in the embodiment in FIG. 8, cloud infrastructure system 802 may include infrastructure resources 830 that are utilized for facilitating the provision of various cloud services offered by cloud infrastructure system 802. Infrastructure resources 830 may include, for example, processing resources, storage or memory resources, networking resources, and the like.

In certain embodiments, to facilitate efficient provisioning of these resources for supporting the various cloud services provided by cloud infrastructure system 802 for different customers, the resources may be bundled into sets of resources or resource modules (also referred to as “pods”). Each resource module or pod may comprise a pre-integrated and optimized combination of resources of one or more types. In certain embodiments, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 802 may itself internally use services 832 that are shared by different components of cloud infrastructure system 802 and which facilitate the provisioning of services by cloud infrastructure system 802. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

Cloud infrastructure system 802 may comprise multiple subsystems. These subsystems may be implemented in software, or hardware, or combinations thereof. As depicted in FIG. 8, the subsystems may include a user interface subsystem 812 that enables users or customers of cloud infrastructure system 802 to interact with cloud infrastructure system 802. User interface subsystem 812 may include various different interfaces such as a web interface 814, an online store interface 816 where cloud services provided by cloud infrastructure system 802 are advertised and are purchasable by a consumer, and other interfaces 818. For example, a customer may, using a client device, request (service request 834) one or more services provided by cloud infrastructure system 802 using one or more of interfaces 814, 816, and 818. For example, a customer may access the online store, browse cloud services offered by cloud infrastructure system 802, and place a subscription order for one or more services offered by cloud infrastructure system 802 that the customer wishes to subscribe to. The service request may include information identifying the customer and one or more services that the customer desires to subscribe to. For example, a customer may place a subscription order for a storage-related service offered by cloud infrastructure system 802. As part of the order, the customer may provide information identifying an application for which the service is to be provided and the application storage profile information for the application.

In certain embodiments, such as the embodiment depicted in FIG. 8, cloud infrastructure system 802 may comprise an order management subsystem (OMS) 820 that is configured to process the new order. As part of this processing, OMS 820 may be configured to: create an account for the customer, if not done already; receive billing and/or accounting information from the customer that is to be used for billing the customer for providing the requested service to the customer; verify the customer information; upon verification, book the order for the customer; and orchestrate various workflows to prepare the order for provisioning.

Once properly validated, OMS 820 may then invoke the order provisioning subsystem (OPS) 824 that is configured to provision resources for the order including processing, memory, and networking resources. The provisioning may include allocating resources for the order and configuring the resources to facilitate the service requested by the customer order. The manner in which resources are provisioned for an order and the type of the provisioned resources may depend upon the type of cloud service that has been ordered by the customer. For example, according to one workflow, OPS 824 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting customer for providing the requested service.

Cloud infrastructure system 802 may send a response or notification 844 to the requesting customer to indicate when the requested service is now ready for use. In some instances, information (e.g., a link) may be sent to the customer that enables the customer to start using and availing the benefits of the requested services.

Cloud infrastructure system 802 may provide services to multiple customers. For each customer, cloud infrastructure system 802 is responsible for managing information related to one or more subscription orders received from the customer, maintaining customer data related to the orders, and providing the requested services to the customer. Cloud infrastructure system 802 may also collect usage statistics regarding a customer's use of subscribed services. For example, statistics may be collected for the amount of storage used, the amount of data transferred, the number of users, and the amount of system up time and system down time, and the like. This usage information may be used to bill the customer. Billing may be done, for example, on a monthly cycle.

Cloud infrastructure system 802 may provide services to multiple customers in parallel. Cloud infrastructure system 802 may store information for these customers, including possibly proprietary information. In certain embodiments, cloud infrastructure system 802 comprises an identity management subsystem (IMS) 828 that is configured to manage customers information and provide the separation of the managed information such that information related to one customer is not accessible by another customer. IMS 828 may be configured to provide various security-related services such as identity services, such as information access management, authentication and authorization services, services for managing customer identities and roles and related capabilities, and the like.

FIG. 9 illustrates an exemplary computer system 900 that may be used to implement certain embodiments. As shown in FIG. 9, computer system 900 includes various subsystems including a processing subsystem 904 that communicates with a number of other subsystems via a bus subsystem 902. These other subsystems may include a processing acceleration unit 906, an I/O subsystem 908, a storage subsystem 918, and a communications subsystem 924. Storage subsystem 918 may include non-transitory computer-readable storage media including storage media 922 and a system memory 910.

Bus subsystem 902 provides a mechanism for letting the various components and subsystems of computer system 900 communicate with each other as intended. Although bus subsystem 902 is shown schematically as a single bus, alternative embodiments of the bus subsystem may utilize multiple buses. Bus subsystem 902 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 904 controls the operation of computer system 900 and may comprise one or more processors, application specific integrated circuits (ASICs), or field programmable gate arrays (FPGAs). The processors may include be single core or multicore processors. The processing resources of computer system 900 can be organized into one or more processing units 932, 934, etc. A processing unit may include one or more processors, one or more cores from the same or different processors, a combination of cores and processors, or other combinations of cores and processors. In some embodiments, processing subsystem 904 can include one or more special purpose co-processors such as graphics processors, digital signal processors (DSPs), or the like. In some embodiments, some or all of the processing units of processing subsystem 904 can be implemented using customized circuits, such as application specific integrated circuits (ASICs), or field programmable gate arrays (FPGAs).

In some embodiments, the processing units in processing subsystem 904 can execute instructions stored in system memory 910 or on computer readable storage media 922. In various embodiments, the processing units can execute a variety of programs or code instructions and can maintain multiple concurrently executing programs or processes. At any given time, some or all of the program code to be executed can be resident in system memory 910 and/or on computer-readable storage media 922 including potentially on one or more storage devices. Through suitable programming, processing subsystem 904 can provide various functionalities described above. In instances where computer system 900 is executing one or more virtual machines, one or more processing units may be allocated to each virtual machine.

In certain embodiments, a processing acceleration unit 906 may optionally be provided for performing customized processing or for off-loading some of the processing performed by processing subsystem 904 so as to accelerate the overall processing performed by computer system 900.

I/O subsystem 908 may include devices and mechanisms for inputting information to computer system 900 and/or for outputting information from or via computer system 900. In general, use of the term input device is intended to include all possible types of devices and mechanisms for inputting information to computer system 900. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Microsoft Kinect® motion sensor that enables users to control and interact with an input device, the Microsoft Xbox® 360 game controller, devices that provide an interface for receiving input using gestures and spoken commands. User interface input devices may also include eye gesture recognition devices such as the Google Glass® blink detector that detects eye activity (e.g., “blinking” while taking pictures and/or making a menu selection) from users and transforms the eye gestures as inputs to an input device (e.g., Google) Glass®. Additionally, user interface input devices may include voice recognition sensing devices that enable users to interact with voice recognition systems (e.g., Siri® navigator) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments and the like.

In general, use of the term output device is intended to include all possible types of devices and mechanisms for outputting information from computer system 900 to a user or other computer. User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. For example, user interface output devices may include, without limitation, a variety of display devices that visually convey text, graphics and audio/video information such as monitors, printers, speakers, headphones, automotive navigation systems, plotters, voice output devices, and modems.

Storage subsystem 918 provides a repository or data store for storing information and data that is used by computer system 900. Storage subsystem 918 provides a tangible non-transitory computer-readable storage medium for storing the basic programming and data constructs that provide the functionality of some embodiments. Storage subsystem 918 may store software (e.g., programs, code modules, instructions) that when executed by processing subsystem 904 provides the functionality described above. The software may be executed by one or more processing units of processing subsystem 904. Storage subsystem 918 may also provide a repository for storing data used in accordance with the teachings of this disclosure.

Storage subsystem 918 may include one or more non-transitory memory devices, including volatile and non-volatile memory devices. As shown in FIG. 9, storage subsystem 918 includes a system memory 910 and a computer-readable storage media 922. System memory 910 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 900, such as during start-up, may typically be stored in the ROM. The RAM typically contains data and/or program modules that are presently being operated and executed by processing subsystem 904. In some implementations, system memory 910 may include multiple different types of memory, such as static random access memory (SRAM), dynamic random access memory (DRAM), and the like.

By way of example, and not limitation, as depicted in FIG. 9, system memory 910 may load application programs 912 that are being executed, which may include various applications such as Web browsers, mid-tier applications, relational database management systems (RDBMS), etc., program data 914, and an operating system 916. By way of example, operating system 916 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, Palm® OS operating systems, and others.

Computer-readable storage media 922 may store programming and data constructs that provide the functionality of some embodiments. Computer-readable media 922 may provide storage of computer-readable instructions, data structures, program modules, and other data for computer system 900. Software (programs, code modules, instructions) that, when executed by processing subsystem 904 provides the functionality described above, may be stored in storage subsystem 918. By way of example, computer-readable storage media 922 may include non-volatile memory such as a hard disk drive, a magnetic disk drive, an optical disk drive such as a CD ROM, DVD, a Blu-Ray® disk, or other optical media. Computer-readable storage media 922 may include, but is not limited to, Zip® drives, flash memory cards, universal serial bus (USB) flash drives, secure digital (SD) cards, DVD disks, digital video tape, and the like. Computer-readable storage media 922 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs.

In certain embodiments, storage subsystem 918 may also include a computer-readable storage media reader 920 that can further be connected to computer-readable storage media 922. Reader 920 may receive and be configured to read data from a memory device such as a disk, a flash drive, etc.

In certain embodiments, computer system 900 may support virtualization technologies, including but not limited to virtualization of processing and memory resources. For example, computer system 900 may provide support for executing one or more virtual machines. In certain embodiments, computer system 900 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 900. Accordingly, multiple operating systems may potentially be run concurrently by computer system 900.

Communications subsystem 924 provides an interface to other computer systems and networks. Communications subsystem 924 serves as an interface for receiving data from and transmitting data to other systems from computer system 900. For example, communications subsystem 924 may enable computer system 900 to establish a communication channel to one or more client devices via the Internet for receiving and sending information from and to the client devices.

Communication subsystem 924 may support both wired and/or wireless communication protocols. For example, in certain embodiments, communications subsystem 924 may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.XX family standards, or other mobile communication technologies, or any combination thereof), global positioning system (GPS) receiver components, and/or other components. In some embodiments communications subsystem 924 can provide wired network connectivity (e.g., Ethernet) in addition to or instead of a wireless interface.

Communication subsystem 924 can receive and transmit data in various forms. For example, in some embodiments, in addition to other forms, communications subsystem 924 may receive input communications in the form of structured and/or unstructured data feeds 926, event streams 928, event updates 930, and the like. For example, communications subsystem 924 may be configured to receive (or send) data feeds 926 in real-time from users of social media networks and/or other communication services such as Twitter® feeds, Facebook® updates, web feeds such as Rich Site Summary (RSS) feeds, and/or real-time updates from one or more third party information sources.

In certain embodiments, communications subsystem 924 may be configured to receive data in the form of continuous data streams, which may include event streams 928 of real-time events and/or event updates 930, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 924 may also be configured to communicate data from computer system 900 to other computer systems or networks. The data may be communicated in various different forms such as structured and/or unstructured data feeds 926, event streams 928, event updates 930, and the like to one or more databases that may be in communication with one or more streaming data source computers coupled to computer system 900.

Computer system 900 can be one of various types, including a handheld portable device (e.g., an iPhone® cellular phone, an iPad® computing tablet, a PDA), a wearable device (e.g., a Google Glass® head mounted display), a personal computer, a workstation, a mainframe, a kiosk, a server rack, or any other data processing system. Due to the ever-changing nature of computers and networks, the description of computer system 900 depicted in FIG. 9 is intended only as a specific example. Many other configurations having more or fewer components than the system depicted in FIG. 9 are possible. Based on the disclosure and teachings provided herein, a person of ordinary skill in the art will appreciate other ways and/or methods to implement the various embodiments.

Although specific embodiments have been described, various modifications, alterations, alternative constructions, and equivalents are possible. Embodiments are not restricted to operation within certain specific data processing environments, but are free to operate within a plurality of data processing environments. Additionally, although certain embodiments have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described embodiments may be used individually or jointly.

Further, while certain embodiments have been described using a particular combination of hardware and software, it should be recognized that other combinations of hardware and software are also possible. Certain embodiments may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of other embodiments. Rather, the preceding description of the embodiments will provide those skilled in the art with an enabling description for implementing various embodiments. Various changes may be made in the function and arrangement of elements.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A method for automatic opportunity evaluation and salvage, the method comprising:
classifying a plurality of opportunities within a multi-dimensional space, wherein:
each dimension of the multi-dimensional space is associated with a variable of a plurality of variables,
each variable of the plurality of variables is relevant to at least one of the plurality of opportunities, and
the classification comprises:
grouping subsets of the plurality of opportunities into a plurality of local neighborhoods; and
assigning a score having a first value or a second value to each of the plurality of opportunities based on a model of the multi-dimensional space, wherein the first value indicates a positive outcome and the second value indicates a negative outcome;
identifying a subset of the plurality of variables in each of the plurality of local neighborhoods;
for a first opportunity of the plurality of opportunities having an indicator of the negative outcome and in a first local neighborhood of the plurality of local neighborhoods:
identifying, based on at least one of the subset of the variables, a second opportunity within the first local neighborhood having the indicator of the positive outcome;
calculating a distance, based on associated variables of the subset of the plurality of variables for the first local neighborhood, between the first opportunity and the second opportunity having the indicator of the positive outcome;
executing a simulation to find a shortest path, based on the calculated distance, that changes the score for the first opportunity from the second value to the first value; and
generating a recommendation for the first opportunity based on the shortest path.

2. The method of claim 1, wherein identifying the subset of the plurality of variables comprises selecting the subset of the plurality of variables for each local neighborhood having the greatest gradient change within the local neighborhood.

3. The method of claim 1, wherein executing the simulation comprises identifying a list of the plurality of variables that, when changed for the first opportunity, changes the score for the first opportunity from the second value to the first value, and wherein generating the recommendation for the first opportunity is further based on the list of the plurality of variables.

4. The method of claim 1, further comprising:
generating a natural language message based on the recommendation to provide to a sales representative in a graphical user interface.

5. The method of claim 1, wherein the grouping subsets of the plurality of opportunities into a plurality of local neighborhoods is based at least in part on at least one of a size of each opportunity, timing of each opportunity, one or more products involved in each opportunity, or similarities of activities in each opportunity.

6. The method of claim 1, further comprising:
capturing first episodic memory of at least one action performed by a first sales representative for the first opportunity;
capturing second episodic memory of at least one action performed by a second sales representative for the second opportunity; and
determining that the at least one action performed by the second sales representative is related to at least one of the associated variables used to calculate the distance between the first opportunity and the second opportunity,
wherein generating the recommendation is further based on the at least one action performed by the second sales representative that differs from the at least one action performed by the first sales representative.

7. The method of claim 1, wherein assigning the score to the first opportunity comprises at least one of:
comparing an activity level between the first opportunity with the second opportunity;
identifying a frequency of change of a projected close date of the first opportunity;
identifying a frequency of deal value change of the first opportunity; or
identifying a progression rate for the first opportunity.

8. The method of claim 1, further comprising:
calculating a boundary between opportunities having the first value and opportunities having the second value within the first local neighborhood; and
calculating a second distance, based on the associated variables of the subset of the plurality of variables for the first local neighborhood, between the first opportunity and the boundary,
wherein executing the simulation further comprises finding a second shortest path, based on the second distance, between the first opportunity and the boundary, and
wherein generating the recommendation for the first opportunity is further based on the second shortest path between the first opportunity and the boundary.

9. A system, comprising
one or more processors; and
a memory having stored thereon instructions that, when executed by the one or more processors, cause the one or more processors to:
classify a plurality of opportunities within a multi-dimensional space, wherein:
each dimension of the multi-dimensional space is associated with a variable of a plurality of variables,
each variable of the plurality of variables is relevant to at least one of the plurality of opportunities, and
the instructions to classify the plurality of opportunities comprise instructions that, when executed by the one or more processors, cause the one or more processors to:
group subsets of the plurality of opportunities into a plurality of local neighborhoods; and
assign a score having a first value or a second value to each of the plurality of opportunities based on a model of the multi-dimensional space, wherein the first value indicates a positive outcome and the second value indicates a negative outcome;
identify a subset of the plurality of variables in each of the plurality of local neighborhoods; and
for a first opportunity of the plurality of opportunities having an indicator of the negative outcome and in a first local neighborhood of the plurality of local neighborhoods:
identify, based on at least one of the subset of the variables, a second opportunity within the first local neighborhood having the indicator of the positive outcome;
calculate a distance, based on associated variables of the subset of the plurality of variables for the first local neighborhood, between the first opportunity and the second opportunity having the indicator of the positive outcome;
execute a simulation to find a shortest path, based on the calculated distance, that changes the score for the first opportunity from the second value to the first value; and
generate a recommendation for the first opportunity based on the shortest path.

10. The system of claim 9, wherein the instructions to identify the subset of the plurality of variables comprises further instructions that, when executed by the one or more processors, cause the one or more processors to select the subset of the plurality of variables having the greatest gradient change within the neighborhood.

11. The system of claim 9, wherein the instructions to execute the simulation search comprises further instructions that, when executed by the one or more processors, cause the one or more processors to identify a list of the plurality of variables that, when changed for the first opportunity, changes the score for the first opportunity from the second value to the first value, wherein generating the recommendation for the first opportunity is further based on the list of the plurality of variables.

12. The system of claim 9, wherein the memory comprises further instructions that, when executed by the one or more processors, cause the one or more processors to:
generate a natural language message based on the recommendation; and
transmit the natural language message to a device of a sales representative in a graphical user interface.

13. The system of claim 9, wherein the grouping subsets of the plurality of opportunities into local neighborhoods is based at least in part on at least one of a size of each opportunity, timing of each opportunity, one or more products involved in each opportunity, or similarities of activities in each opportunity.

14. The system of claim 9, wherein the memory comprises further instructions that, when executed by the one or more processors, cause the one or more processors to:
capture first episodic memory of at least one action performed by a first sales representative for the first opportunity;
capture second episodic memory of at least one action performed by a second sales representative for the at least one opportunity within the same neighborhood having the indicator of the positive outcome; and
determine that the at least one action performed by the second sales representative is related to at least one of the associated variables,
wherein generating the recommendation is further based on the at least one action performed by the second sales representative that differs from the at least one action performed by the first sales representative.

15. The system of claim 9, wherein assigning the first value or the second value to one of the plurality of opportunities comprises at least one of:
compare an activity level between the one of the plurality of opportunities with a known opportunity having a known positive outcome;
identifying a frequency of change of a projected close date of the one of the plurality of opportunities;
identifying a frequency of deal value change of the one of the plurality of opportunities; or
identifying a progression rate for the one of the plurality of opportunities.

16. The system of claim 9, wherein the memory comprises further instructions that, when executed by the one or more processors, cause the one or more processors to:
calculate a boundary, within each of the plurality of local neighborhoods, between opportunities having the first value indicating a positive outcome and opportunities having the second value indicating a negative outcome; and
calculate a distance, based on associated variables of the plurality of variables, between the first opportunity and the boundary, wherein calculating the distance is based on the at least one of the subset of the variables for the local neighborhood,
wherein executing the simulation further comprises finding a shortest distance, based on the associated variables, between the first opportunity and the boundary, and
wherein generating the recommendation for the first opportunity is further based on the shortest distance between the first opportunity and the boundary.

17. A computer-readable media having stored thereon instructions that, when executed by the one or more processors, cause the one or more processors to:
classify a plurality of opportunities within a multi-dimensional space, wherein:
each dimension of the multi-dimensional space is associated with a variable of a plurality of variables,
each variable of the plurality of variables is relevant to at least one of the plurality of opportunities, and
the instructions to classify the plurality of opportunities comprise instructions that, when executed by the one or more processors, cause the one or more processors to:
group subsets of the plurality of opportunities into a plurality of local neighborhoods; and
assign a score having a first value or a second value to each of the plurality of opportunities based on a model of the multi-dimensional space, wherein the first value indicates a positive outcome and the second value indicates a negative outcome;
identify a subset of the plurality of variables in each of the plurality of local neighborhoods; and
for a first opportunity of the plurality of opportunities having an indicator of the negative outcome and in a first local neighborhood of the plurality of local neighborhoods:
identify, based on at least one of the subset of the variables, a second opportunity within the first local neighborhood having the indicator of the positive outcome;
calculate a distance, based on associated variables of the subset of the plurality of variables for the first local neighborhood, between the first opportunity and the second opportunity having the indicator of the positive outcome;
execute a simulation to find a shortest path, based on the calculated distance, that changes the score for the first opportunity from the second value to the first value; and
generate a recommendation for the first opportunity based on the shortest path.

18. The computer-readable media of claim 17, wherein the instructions to identify the subset of the plurality of variables comprises further instructions that, when executed by the one or more processors, cause the one or more processors to select the subset of the plurality of variables having the greatest gradient change within the neighborhood.

19. The computer-readable media of claim 17, wherein the instructions to execute the simulation search comprises further instructions that, when executed by the one or more processors, cause the one or more processors to identify a list of the plurality of variables that, when changed for the first opportunity, changes the score for the first opportunity from the second value to the first value, wherein generating the recommendation for the first opportunity is further based on the list of the plurality of variables.

20. The computer-readable media of claim 17, comprising further instructions that, when executed by the one or more processors, cause the one or more processors to:
generate a natural language message based on the recommendation; and
transmit the natural language message to a device of a sales representative in a graphical user interface.
